(19) United States
(12) Patent Application Publication
(10) Pub. No.: US 2024/0114163 A1
(43) Pub. Date: Apr. 4, 2024

(54) ENCODING APPARATUS PERFORMING INTER PREDICTION OPERATION BASED ON AN OVERLAP FRAME AND OPERATING METHOD THEREOF

(71) Applicant: Electronics and Telecommunications Research Institute, Daejeon (KR)

(72) Inventors: Eun Young CHANG, Daejeon (KR); Euee S JANG, Seoul (KR); Xin LI, Seoul (KR); Jihun CHA, Daejeon (KR); Tianyu DONG, Seoul (KR); Jae Young AHN, Daejeon (KR)

(73) Assignee: Electronics and Telecommunications Research Institute, Daejeon (KR)

(21) Appl. No.: 18/468,427

(22) Filed: Sep. 15, 2023

(30) Foreign Application Priority Data
Oct. 4, 2022 (KR) 10-2022-0126310
Mar. 15, 2023 (KR) 10-2023-0033930

(51) Int. Cl. H04N 19/513; H04N 19/105; H04N 19/172

(52) U.S. Cl. CPC H04N 19/513; H04N 19/105; H04N 19/172

(57) ABSTRACT

Disclosed is an encoder which receives first to third input frames included first intra period and outputs a bitstream corresponding to the third input frame. The encoder includes a motion compensation unit that generates a first reference frame corresponding to the first input frame and a second reference frame corresponding to the second input frame, a union operation unit that generates an overlap frame by performing a union operation based on the first reference frame and the second reference frame, and an inter prediction unit that generates an occupancy code by performing an inter prediction operation on the overlap frame and the third input frame. In this case, the bitstream includes the occupancy code.

### CROSS-REFERENCE TO RELATED APPLICATIONS

This application claims priority under 35 U.S.C. § 119(a) to Korean Patent Application Nos. 10-2022-0126310, filed on Oct. 4, 2022, and 10-2023-0033930, filed on Mar. 15, 2023, respectively, in the Korean Intellectual Property Office, the disclosures of which are incorporated by reference herein in their entireties.

### BACKGROUND

Embodiments of the present disclosure described herein relate to an encoding device for outputting a bitstream by encoding 3D point cloud data and an operating method thereof. More particularly, embodiments of the present disclosure described herein relate to an encoding device for performing an inter prediction operation based on an overlap frame and an operating method thereof.

A point cloud may refer to a set of points existing in a 3D (three dimensional) space. The point cloud may be applied to various fields such as a real-time 3D immersive telepresence, a geographic information system (GIS), a navigation service and so on.

However, since the point cloud includes real spatial information of an object, the point cloud has larger data size than a 2D image. Accordingly, various encoding and compression methods for processing the point cloud data are being studied.

### SUMMARY

Embodiments of the present disclosure are to solve the above-mentioned technical problem. More particularly, embodiments of the present disclosure provide an encoding device for performing an inter prediction operation based on an overlap frame and an operating method thereof.

According to an embodiment of the present disclosure, disclosed is an encoder which receives first to third input frames included in a first intra period and outputs a bitstream corresponding to the third input frame. The encoder includes a motion compensation unit that generates a first reference frame corresponding to the first input frame and a second reference frame corresponding to the second input frame, a union operation unit that generates an overlap frame by performing a union operation based on the first reference frame and the second reference frame, and an inter prediction unit that generates an occupancy code by performing an inter prediction operation on the overlap frame and the third input frame, and the bitstream includes the occupancy code.

According to an embodiment, the first to third input frames may correspond to first to third time information of point cloud data collected by a LiDAR device outside the encoder, respectively.

According to an embodiment, the first input frame may include first detection points with respect to objects, the second input frame may include second detection points with respect to the objects, and the third input frame may include third detection points with respect to the objects.

According to an embodiment, the first reference frame may include first motion compensation detection points corresponding to the first detection points, and the second reference frame may include second motion compensation detection points corresponding to the second detection points.

According to an embodiment, the overlap frame may include the first motion compensation detection points and the second motion compensation detection points.

According to an embodiment, the first detection points may be included in a first detection area of the LiDAR device at the first time, the second detection points may be included in a second detection area of the LiDAR device at the second time, and the third detection points may be included in a third detection area of the LiDAR device at the third time, and the overlap frame may include motion compensation detection points included in the third detection area among the first motion compensation detection points and the second motion compensation detection points.

According to an embodiment, the overlap frame may not include a motion compensation detection point which is not included in the third detection area among the first motion compensation detection points and the second motion compensation detection points.

According to an embodiment, the union operation may be performed with respect to any combination of a plurality of reference frames including the first reference frame and the second reference frame.

According to an embodiment, the bitstream may include a bit area indicating reference frames used in the union operation among the plurality of reference frames.

According to an embodiment of the present disclosure, a method of operating an encoder which encodes first to n-th input frames to generate first to n-th bitstreams, includes generating a first converted frame and the first bitstream based on the first input frame, and sequentially performing an encoding operation on the second to n-th input frames to generate the second to n-th bitstreams, respectively, and the encoding operation with respect to a k-th input frame among the second to n-th input frames includes generating a (k−1)-th motion vector by performing a motion estimation operation on the k-th input frame and a (k−1)-th converted frame, generating first to (k−1)-th reference frames with respect to the k-th input frame based on first to the (k−1)-th motion vectors, generating a (k−1)-th overlap frame by performing a union operation on the first to (k−1)-th reference frames with respect to the k-th input frame, generating a k-th occupancy code by performing an inter prediction operation on the (k−1)-th overlap frame and the k-th input frame, generating a k-th converted frame based on the k-th occupancy code and the (k−1)-th overlap frame, and generating a k-th bitstream based on the k-th occupancy code and the (k−1)-th motion vector.

According to an embodiment, the first to n-th input frames may be included in the same intra period.

According to an embodiment, the first to n-th input frames may include detection points in different detection areas, respectively.

According to an embodiment, the first to (k−1)-th reference frames with respect to the k-th input frame may be a result of performing a motion compensation operation on the first to (k−1)-th converted frames on the basis of the k-th input frame, based on the first to (k−1)-th motion vectors, respectively.

According to an embodiment, the (k−1)-th overlap frame may include motion compensated detection points included in each of the first to (k−1)-th reference frames with respect to the k-th input frame.

According to an embodiment, the k-th bitstream may include a first bit area indicating an encoding scheme, a second bit area indicating the (k−1)-th motion vector, and a third bit area indicating the k-th occupancy code.

According to an embodiment of the present disclosure, a method of operating a decoder which decodes first to n-th bitstreams to generate first to n-th decoded frames, includes generating the first decoded frame based on a first occupancy code included in the first bitstream, and sequentially performing a decoding operation on the second to n-th bitstreams to generate the second to n-th decoded frames, respectively, and the decoding operation with respect to a k-th bitstream among the second to n-th bitstreams includes generating first to (k−1)-th reference frames with respect to the k-th bitstream based on first to (k−1)-th motion vectors, generating a k-th inter prediction frame based on the first to (k−1)-th reference frames with respect to the k-th bitstream, and generating a k-th decoded frame based on the k-th inter prediction frame and a k-th occupancy code.

According to an embodiment, the k-th inter prediction frame may be an overlap frame generated through a union operation of the first to (k−1)-th reference frames.

According to an embodiment, the k-th bitstream may include a first bit area indicating an encoding scheme, a second bit area indicating the (k−1)-th motion vector, and a third bit area indicating the k-th occupancy code.

According to an embodiment, the k-th inter prediction frame may be selected from a k-th inter prediction frame group including a plurality of overlap frames respectively generated through a union operation on arbitrary combinations of the first to (k−1)-th reference frames and the first to (k−1)-th reference frames.

According to an embodiment, the k-th bitstream may include a first bit area indicating an encoding scheme, a second bit area indicating the (k−1)-th motion vector, a third bit area indicating the k-th occupancy code, and a fourth bit area indicating reference frames used to generate the k-th inter prediction frame among the first to (k−1)-th reference frames.

### BRIEF DESCRIPTION OF THE FIGURES

A detailed description of each drawing is provided to facilitate a more thorough understanding of the drawings referenced in the detailed description of the present disclosure.

FIG. 1 is a block diagram illustrating an encoding device, according to an embodiment of the present disclosure.

FIG. 2 is a diagram illustrating a plurality of input frames of FIG. 1.

FIG. 3 is a diagram illustrating an encoder 100 of FIG. 1 in more detail.

FIG. 4 is a diagram illustrating an operation of an encoder of FIG. 3, according to an embodiment.

FIG. 5 is a flowchart illustrating an operating method of an encoding device of FIG. 1, according to an embodiment of FIG. 4.

FIG. 6 is a table illustrating a target frame and an inter prediction frame, according to the embodiment of FIG. 4.

FIG. 7 is a diagram illustrating an operation of an encoder of FIG. 3, according to an embodiment of the present disclosure.

FIG. 8 is a flowchart illustrating an operating method of an encoding device of FIG. 1, according to the embodiment of FIG. 7.

FIG. 9 is a flowchart illustrating an embodiment of operation S140 of FIG. 8.

FIG. 10 is a diagram illustrating operations S142 to S144 of FIG. 9.

FIG. 11 is a diagram illustrating an operation of the union operation unit of FIG. 3.

FIG. 12 is a table illustrating a target frame and an inter prediction frame, according to an embodiment of FIG. 9.

FIG. 13 is a diagram illustrating an operation of an encoder of FIG. 3, according to another embodiment of the present disclosure.

FIG. 14 is a flowchart illustrating another embodiment of operation S140 of FIG. 8, according to an embodiment of FIG. 13.

FIG. 15 is a diagram illustrating operations S242 to S245 of FIG. 14.

FIG. 16 is a table illustrating a target frame and an inter prediction frame group, according to an embodiment of FIG. 13.

FIG. 17 is a diagram illustrating a configuration of a bitstream, according to an embodiment of the present disclosure.

FIG. 18 is a diagram illustrating a decoder, according to an embodiment of the present disclosure.

FIG. 19 is a diagram illustrating an operation of a decoder of FIG. 18, according to an embodiment of the present disclosure.

FIG. 20 is a flowchart illustrating an operating method of a decoding device of FIG. 18, according to an embodiment of FIG. 19.

FIG. 21 is a flowchart illustrating operation S330 of FIG. 20 in more detail.

FIG. 22 is a diagram illustrating an operation of a decoder of FIG. 18, according to another embodiment of the present disclosure.

FIG. 23 is a flowchart illustrating another embodiment of operation S330 of FIG. 20, according to an embodiment of FIG. 22.

FIG. 24 is a block diagram illustrating a LiDAR system, according to an embodiment of the present disclosure.

### DETAILED DESCRIPTION

Hereinafter, embodiments of the present disclosure will be described clearly and in detail such that those skilled in the art may easily carry out the present disclosure. Specific details such as detailed components and structures are merely provided to assist the overall understanding of the embodiments of the present disclosure. Therefore, it should be apparent to those skilled in the art that various changes and modifications of the embodiments described herein may be made without departing from the scope and spirit of the present disclosure. Moreover, descriptions of well-known functions and structures will be omitted for clarity and conciseness. Components in the following drawings or in the detailed description may be connected with any other components besides the components illustrated in the drawings or described in the detailed description. The terms used in the specification are terms defined in consideration of the functions in the present disclosure and are not limited to a specific function. The definitions of the terms should be determined based on the contents throughout the specification.

Components that are described in the detailed description with reference to the terms “driver”, “block”, etc. will be implemented with software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, an inertial sensor, a micro-electro-mechanical-system (MEMS), a passive element, or a combination thereof.

FIG. 1 is a block diagram illustrating an encoding device, according to an embodiment of the present disclosure. Referring to FIG. 1, an encoding device ED may include a transform unit TF and an encoder 100. The encoding device ED may encode point cloud data PC to output a bitstream BS. Hereinafter, an operation of each of the components of the encoding device ED will be described in detail.

The transform unit TF may receive the point cloud data PC from an external device (not illustrated). The point cloud data PC may include information about points existing in a 3D space. For example, the point cloud data PC may include x-axis coordinate information, y-axis coordinate information, and z-axis coordinate information with respect to an object existing in the 3D space. However, the scope of the present disclosure is not limited thereto, and the point cloud data PC may include various types of coordinate information such as Cartesian coordinates, cylindrical coordinates, and spherical coordinates.

In an embodiment, the point cloud data PC may be collected from various types of external devices (not illustrated) such as a LiDAR device, an RGB-D device, a 3D scanner device, etc. Hereinafter, an embodiment in which the point cloud data PC is collected by the LiDAR device will be representatively described for convenience of description. However, the scope of the present disclosure is not limited thereto.

The transform unit TF may transform the point cloud data PC to output a plurality of input frames IFM. For example, the transform unit TF may perform operations such as scaling, translation, rotation, and skew on the point cloud data PC. The plurality of input frames IFM may be in a form suitable for processing by internal components of the encoding device ED.

In an embodiment, the plurality of input frames IFM may be referred to as internal frames, raw frames, or internal format frames.

In an embodiment, each of the plurality of input frames IFM may include detection points. For example, the detection points may include geometric information (e.g., physical coordinate information) of an object detected by an external device. However, the scope of the present disclosure is not limited thereto, and the detection points may include various attribute information such as object reflection intensity information, color information, transparency information, normal vector information, material information, etc. However, hereinafter, an embodiment in which the detection points represent geometric information (e.g., x, y, and z coordinate information) of an object will be described as a representative example.

In an embodiment, each of the plurality of input frames IFM may correspond to point cloud data PC of different times. In detail, each of the plurality of input frames IFM may correspond to information about different times of the point cloud data PC. For example, each of the plurality of frames FM may have a time-sequential order.

In an embodiment, the point cloud data PC may be collected based on a moving LiDAR device. In detail, the LiDAR device may detect an object included in a moving detection area. In this case, the center of the detection area (e.g., the physical location of the LiDAR device) may be referred to as a detection bull.

In an embodiment, each of the plurality of input frames IFM may be included in the same intra period (or intra frame period).

The encoder 100 may receive the plurality of input frames IFM to generate the plurality of bitstreams BS. For example, the encoder 100 may sequentially encode the plurality of input frames IFM to sequentially generate the plurality of bitstreams BS. However, the scope of the present disclosure is not limited thereto, and the encoder 100 may perform an encoding operation on the plurality of input frames IFM in an order different from the input order. For example, among the plurality of input frames IFM, a fourth input frame may be encoded prior to a third input frame inputted prior to the fourth input frame. However, in the following, for concise description, an embodiment in which the plurality of input frames IFM are sequentially encoded will be representatively described. A detailed configuration and an operation of the encoder 100 will be described in more detail with reference to the following drawings.

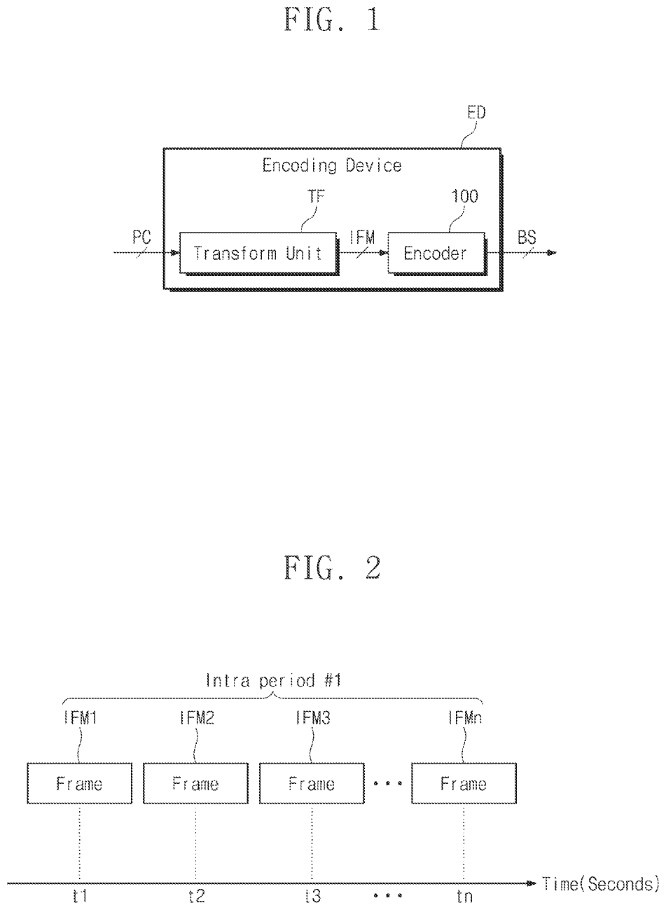

FIG. 2 is a diagram illustrating a plurality of input frames of FIG. 1. Referring to FIGS. 1 and 2, the transform unit TF may convert point cloud data PC to output the plurality of input frames IFM.

The plurality of input frames IFM may have a time-sequential order. For example, the plurality of input frames IFM may include the first to n-th input frames IFM1 to IFMn. In this case, the first to n-th input frames IFM1 to IFMn may respectively correspond to first to n-th time information t1 to tn of the point cloud data PC.

The first to n-th input frames IFM1 to IFMn may be included in the same intra period. For example, the first to n-th input frames IFM1 to IFMn may be included in a first intra period (intra period #1).

In an embodiment, an intra period may refer to a unit in which an encoding operation is performed. For example, an encoding operation with respect to a target frame (e.g., a first input frame within a first intra period) having the earliest order among frames included in a single intra period may be performed without considering an input frame preceding the target frame.

Hereinafter, for convenience of description, an encoding operation for the first to n-th input frames IFM1 to IFMn included in a single intra period will be representatively described. However, the scope of the present disclosure is not limited thereto, and a second intra period other than the first intra period may be included in the plurality of input frames IFM. For example, the plurality of input frames IFM may also include an (n+1)-th input frame included in the second intra period.

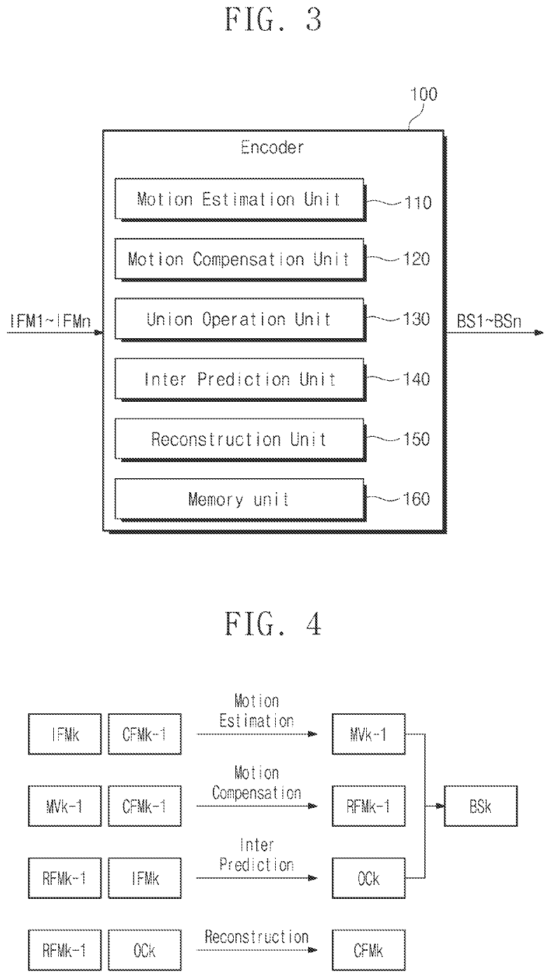

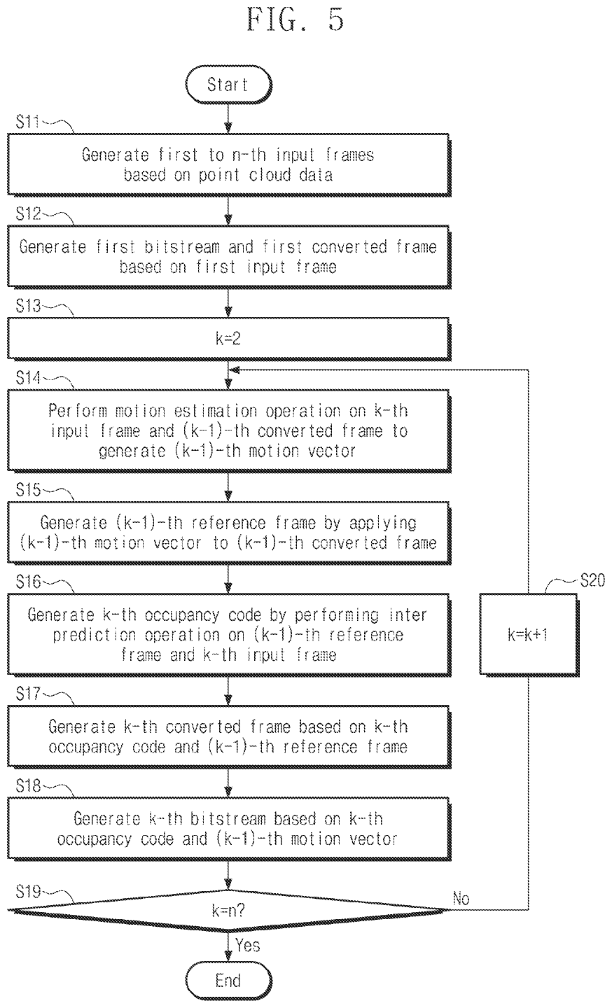

FIG. 3 is a diagram illustrating an encoder 100 of FIG. 1 in more detail.

Referring to FIGS. 1 and 3, the encoder 100 may include a motion estimation unit 110, a motion compensation unit 120, a union operation unit 130, an inter prediction unit 140, a reconstruction unit 150, and a memory unit 160.

The encoder 100 may sequentially perform an encoding operation on the first to n-th input frames IFM1 to IFMn. Hereinafter, for convenience of description, an input frame on which an encoding operation is performed among the first to n-th input frames IFM1 to IFMn will be referred to as a target frame.

The motion estimation unit 110 may perform a motion estimation operation with respect to two different frames. In detail, the motion estimation unit 110 may calculate a motion vector between two different frames. For example, the motion estimation unit 110 may calculate a first motion vector between a first frame and a second frame.

In an embodiment, the motion estimation unit 110 may perform a motion estimation operation based on an iterative closest point (ICP) algorithm.

The motion compensation unit 120 may compensate for a motion between two different frames based on the motion vector. For example, the motion compensation unit 120 may generate a reference frame with respect to the target frame by compensating for the motion of an arbitrary frame based on the target frame. For example, the motion compensation unit 120 may generate a first reference frame with respect to the second frame by multiplying coordinates of detection points included in the first frame by a first motion vector. In this case, the first reference frame with respect to the second frame may refer to a motion-compensated first frame based on the second frame.

In an embodiment, the motion estimation operation and the motion compensation operation may refer to an operation of estimating and compensating for a movement (e.g., translation, rotation, etc.) of a device (e.g., LiDAR device) detecting detection points of a target frame and another frame (for convenience of description, the another frame may be referred to as a comparison frame). For example, the motion estimation operation may be performed by calculating a movement (e.g., translation and rotation) between geometric information (e.g., detection points) of an object included in the target frame and geometric information of an object included in the comparison frame. In more detail, a motion estimation operation may refer to an operation of calculating a motion vector between a target frame and a comparison frame. Meanwhile, a motion compensation operation may refer to an operation of compensating geometric information of objects (e.g., detection points) included in a comparison frame by using a motion vector calculated through a motion estimation operation. In this case, the ‘compensated comparison frame’ may be referred to as a ‘reference frame’, and the ‘detection points included in the reference frame’ may be referred to as ‘motion compensated detection points’. However, the scope of the present disclosure is not limited to the terms described above.

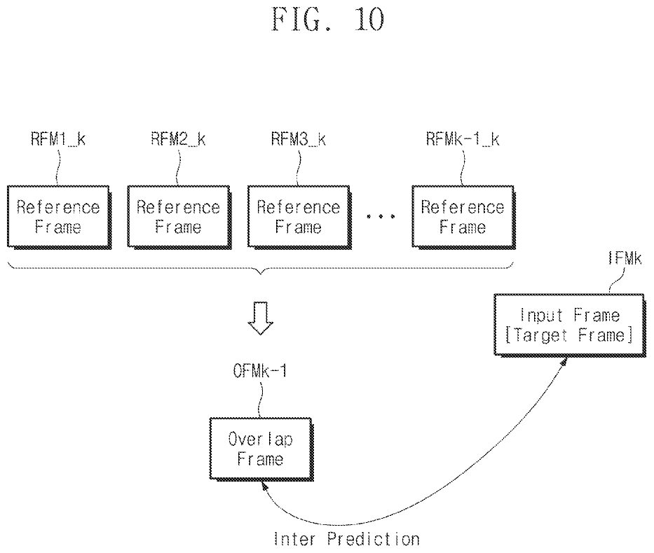

The union operation unit 130 may generate an overlap frame based on an arbitrary combination of reference frames. For example, the union operation unit 130 may generate an overlap frame by performing a union operation on two or more of the reference frames. For example, the overlap frame may be generated through a union (or may also be referred to as an accumulation operation) operation on detection points included in different reference frames. The overlap frame and an operation of the union operation unit 130 will be described in more detail with reference to FIG. 10 below.

The inter prediction unit 140 may generate an occupancy code by performing an inter prediction operation on the inter prediction frame and the target frame. In this case, the inter prediction operation may be an operation of comparing the inter prediction frame with the target frame.

In an embodiment, the inter prediction frame may refer to a frame used to generate an occupancy code through comparison with the target frame. For example, the inter prediction frame may be one of reference frames or one of overlap frames.

In an embodiment, when the inter prediction frame is an overlap frame, the efficiency of the inter prediction operation with respect to the target frame may increase. In more detail, compression efficiency for the target frame may increase. For example, the overlap frame may include more detection points than a reference frame. Therefore, when the inter prediction operation is performed on the overlap frame and the target frame, since more detection points may be considered, compression efficiency for the target frame may be improved.

In an embodiment, the inter prediction unit 140 may perform an inter prediction operation based on an octree structure of an inter prediction frame and a target frame. For example, the inter prediction unit 140 may generate a binary code for the inter prediction frame and the target frame based on the octree structure. The inter prediction unit 140 may analyze an occupancy bit pattern of the binary code of the target frame based on the binary code of the inter prediction frame. In more detail, the inter prediction unit 140 may utilize the binary code for the inter prediction frame and a target frame FMk as input values for an arithmetic coding context. In this case, an occupancy code related to the target frame may be generated.

The reconstruction unit 150 may generate a first converted frame by performing a quantization operation on a first input frame IFM1. In addition, the reconstruction unit 150 may generate a converted frame corresponding to the input frame based on the reference frame and the occupancy code. For convenience of description, the converted frame is referred to using a reference symbol ‘CFM’ in the following.

In an embodiment, the converted frame CFM may refer to a reconstructed frame when a decoding operation is performed based on the bitstream BS. For example, when a decoding operation on a first bitstream BS1 is performed, a first converted frame CFM1 may be reconstructed, and when a decoding operation on the n-th bitstream BSn is performed, an n-th converted frame CFMn may be reconstructed. However, the scope of the present disclosure is not limited thereto.

The memory unit 160 may store information generated while performing an encoding operation on the first to n-th input frames IFM1 to IFMn. For example, the memory unit 160 may temporarily store various information such as motion vectors, converted frames, and overlap frames.

The encoder 100 may generate the first to n-th bitstreams BS1 to BSn by performing an encoding operation on the first to n-th input frames IFM1 to IFMn. In this case, the first bitstream BS1 may include the first occupancy code for the first input frame IFM1. In addition, each of the second to n-th bitstreams BS2 to BSn may include an occupancy code and a motion vector with respect to a corresponding input frame.

FIG. 4 is a diagram illustrating an operation of an encoder of FIG. 3, according to an embodiment. Encoding operations for the second to n-th input frames IFM2 to IFMn will be described with reference to FIGS. 1 to 4. For example, in FIG. 4, an embodiment of a case where a k-th input frame IFMk (i.e., ‘k’ may be an integer greater than 2) among the second to n-th input frames IFM2 to IFMn is a target frame will be representatively described. The encoding operation for the first input frame IFM1 is similar to that described above with reference to FIG. 3, and thus, additional description thereof will be omitted to avoid redundancy.

Continuing to refer to FIG. 4, the encoder 100 may receive the k-th input frame IFMk. The motion estimation unit 110 may perform a motion estimation operation based on the k-th input frame IFMk and a (k−1)-th converted frame CFMk−1. In detail, the motion estimation unit 110 may generate a (k−1)-th motion vector MVk−1 based on the k-th input frame IFMk and the (k−1)-th converted frame CFMk−1.

The motion compensation unit 120 may perform a motion compensation operation on the (k−1)-th converted frame CFMk−1 based on the (k−1)-th motion vector MVk−1. In detail, the motion compensation unit 120 may perform a motion compensation operation on the (k−1)-th converted frame CFMk−1 based on the k-th input frame IFMk. For example, the motion compensation unit 120 may multiply the coordinates of the detection points of the (k−1)-th converted frame CFMK−1 by the (k−1)-th motion vector MVk−1, and then may generate the (k−1)-th reference frame RFMk−1.

The inter prediction unit 140 may generate a k-th occupancy code OCk by performing an inter prediction operation on the (k−1)-th reference frame RFMk−1 and the k-th input frame IFMk.

The reconstruction unit 150 may generate a k-th converted frame CFMk based on the (k−1)-th reference frame RFMk−1 and the k-th occupancy code OCk. The k-th converted frame CFMk may correspond to the k-th input frame IFMk. For example, when a decoding operation is performed based on a k-th bitstream BSk, the k-th converted frame CFMk may be reconstructed. The decoding operation will be described in more detail with reference to FIGS. 18 to 23.

The encoder 100 may generate the k-th bitstream BSk based on the k-th input frame IFMk. In this case, the k-th bitstream BSk may include the k-th occupancy code OCk and the (k−1)-th motion vector MVk−1.

FIG. 5 is a flowchart illustrating an operating method of an encoding device of FIG. 1, according to an embodiment of FIG. 4. Referring to FIGS. 1 to 5, in operation S11, the encoding device ED may generate the first to n-th input frames IFM1 to IFMn based on the point cloud data PD.

In operation S12, the encoding device ED may generate the first bitstream BS1 and the first converted frame CFM1 based on the first input frame IFM1. For example, the encoder 100 may generate the first converted frame CFM1 based on the first input frame IFM1 through the reconstruction unit 150. The encoder 100 may generate a first occupancy code OC1 with respect to the first input frame IFM1. The encoder 100 may generate the first bitstream BS1 based on the first occupancy code OC1. In this case, the first bitstream BS1 may include the first occupancy code OC1.

In operation S13, a variable ‘k’ may be set to ‘2’. The variable ‘k’ is used to describe that an encoding operation is sequentially performed on the second to n-th input frames IFM2 to IFMn, and does not limit the scope of the present disclosure.

In operation S14, the encoding device ED may perform a motion estimation operation on the k-th input frame IFMk and the (k−1)-th converted frame CFMk−1 to generate the (k−1)-th motion vector MVk−1. For example, the motion estimation unit 110 may calculate the (k−1)-th motion vector MVk−1 between the k-th input frame IFMk and the (k−1)-th converted frame CFMk−1.

In an embodiment, the (k−1)-th motion vector MVk−1 may be stored in the memory unit 160.

In operation S15, the encoding device ED may generate the (k−1)-th reference frame RFMk−1 by applying the (k−1)-th motion vector MVk−1 to the (k−1)-th converted frame CFMk−1. For example, the motion compensation unit 120 may multiply the coordinates of the detection points of the (k−1)-th converted frame CFMK−1 by the (k−1)-th motion vector MVk−1, and then may generate the (k−1)-th reference frame RFMk−1. In this case, the (k−1)-th reference frame RFMk−1 may be a motion-compensated frame based on the k-th input frame IFMk (i.e., the target frame).

In operation S16, the encoding device ED may generate the k-th occupancy code OCk by performing an inter prediction operation on the (k−1)-th reference frame RFMk−1 and the k-th input frame. For example, the inter prediction unit 140 may generate the k-th occupancy code OCk by performing an inter prediction operation on the (k−1)-th reference frame RFMk−1 and the k-th input frame.

In operation S17, the encoding device ED may generate the k-th converted frame CFMk based on the k-th occupancy code OCk and the (k−1)-th reference frame RFMk−1. For example, the encoder 100 may generate the k-th converted frame CFMk based on the k-th occupancy code OCk and the (k−1)-th reference frame RFMk−1 through the reconstruction unit 150. In this case, the k-th converted frame CFMk may be used when an encoding operation is performed on a (k+1)-th input frame IFMk+1.

In an embodiment, the k-th converted frame CFMk may be stored in the memory unit 160.

In operation S18, the encoding device ED may generate the k-th bitstream BSk based on the k-th occupancy code OCk and the (k−1)-th motion vector MVk−1. For example, the encoder 100 may generate the k-th bitstream BSk including the k-th occupancy code OCk and the (k−1)-th motion vector MVk−1.

In operation S19, it is determined whether the value of the variable ‘k’ is ‘n’. When the value of the variable ‘k’ is not ‘n’, operation S20 may be performed, and the variable ‘k’ may be increased by ‘1’. When the value of the variable ‘k’ is ‘n’, the operation of the encoding device 100 may end. In detail, in operation S19, it may be determined whether all input frames included in the same intra period are encoded. In operation S20, the target frame may be changed from the k-th input frame IFMk to the (k+1)-th input frame IFMk+1.

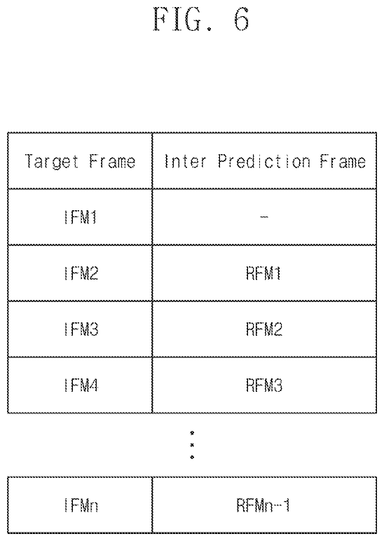

FIG. 6 is a table illustrating a target frame and an inter prediction frame, according to the embodiment of FIG. 4. Referring to FIGS. 3 to 6, the inter prediction unit 140 may perform an inter prediction operation based on the target frame and the inter prediction frame.

When the k-th input frame IFMk is the target frame, the inter prediction unit 140 may perform the inter prediction operation based on the (k−1)-th reference frame RFMk−1. For example, when the second input frame IFM2 is the target frame, the inter prediction unit 140 may perform the inter prediction operation based on the first reference frame RFM1.

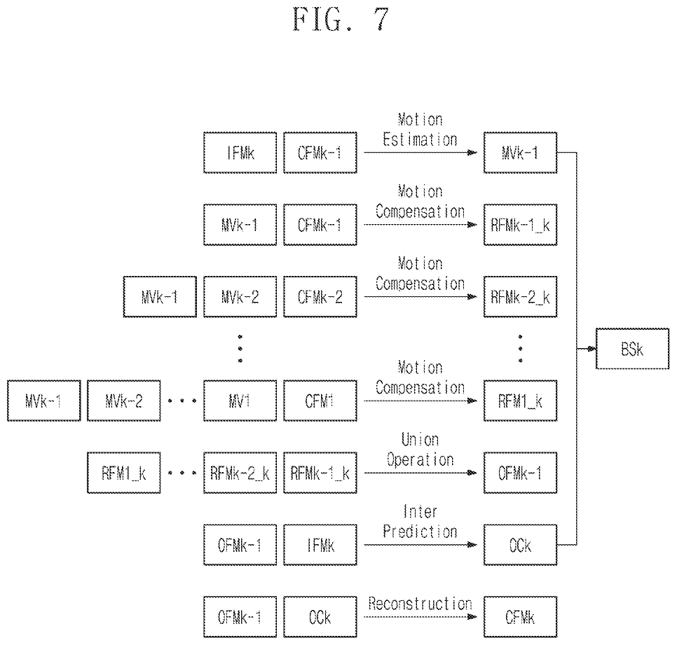

FIG. 7 is a diagram illustrating an operation of an encoder of FIG. 3, according to an embodiment of the present disclosure. With reference to FIGS. 1 to 3 and FIG. 7, encoding operations for the second to n-th input frames IFM2 to IFMn will be described. For example, in FIG. 7, an embodiment of a case where the k-th input frame IFMk (i.e., ‘k’ may be an integer greater than 2) among the second to n-th input frames IFM2 to IFMn is a target frame will be representatively described. Since the encoding operation for the first input frame IFM1 is similar to that described above with reference to FIG. 3, additional description thereof will be omitted to avoid redundancy.

Continuing to refer to FIG. 7, the encoder 100 may receive the k-th input frame IFMk. The motion estimation unit 110 may perform a motion estimation operation based on the k-th input frame IFMk and the (k−1)-th converted frame CFMk−1. In detail, the motion estimation unit 110 may generate the (k−1)-th motion vector MVk−1 based on the k-th input frame IFMk and the (k−1)-th converted frame CFMk−1.

The motion compensation unit 120 may perform a motion compensation operation on the first to (k−1)-th converted frames CFM1 to CFMk−1 based on the first to (k−1)-th motion vectors MV1 to MVk−1. In detail, the motion compensation unit 120 may perform the motion compensation operation on the first to (k−1)-th converted frames CFM1 to CFMk−1 based on the k-th input frame IFMk. For example, the motion compensation unit 120 may multiply the coordinates of the detection points of the (k−1)-th converted frame CFMK−1 by the (k−1)-th motion vector MVk−1 to generate a (k−1)-th reference frame RFMk−1_k with respect to the k-th input frame. The motion compensation unit 120 may multiply the coordinates of the detection points of a (k−2)-th converted frame CFMk−2 by (k−1)-th motion vector MVk−1 and a (k−2)-th motion vector MVk−2 to generate a (k−2)-th reference frame RFMk−2_k with respect to the k-th input frame. As in the above description, the motion compensation unit 120 may multiply the coordinates of the detection points of an i-th converted frame CFMi (where ‘i’ is an integer greater than or equal to ‘1’ and less than ‘k’) by an i-th to (k−1)-th motion vectors MVi to MVk−1 to generate an i-th reference frame RFMi_k with respect to the k-th input frame.

The union operation unit 130 may perform a union operation on ‘the first reference frame RFM1_k with respect to the k-th input frame’ to ‘the (k−1)-th reference frame RFMk−1_k with respect to the k-th input frame’ to generate a (k−1)-th overlap frame OFMk−1.

In an embodiment, the (k−1)-th overlap frame OFMk−1 may include all of the detection points (i.e., motion-compensated detection points) included in ‘the first reference frame RFM1_k with respect to the k-th input frame’ to ‘the (k−1)-th reference frame RFMk−1_k with respect to the k-th input frame’. However, the scope of the present disclosure is not limited thereto.

The inter prediction unit 140 may generate the k-th occupancy code OCk by performing an inter prediction operation on the (k−1)-th overlap frame OFMk−1 and the k-th input frame IFMk.

The reconstruction unit 150 may generate the k-th converted frame CFMk based on the (k−1)-th overlap frame OFMk−1 and the k-th occupancy code OCk. The k-th converted frame CFMk may correspond to the k-th input frame IFMk. For example, when a decoding operation is performed based on a k-th bitstream BSk, the k-th converted frame CFMk may be reconstructed.

The encoder 100 may generate the k-th bitstream BSk based on the k-th input frame IFMk. In this case, the k-th bitstream BSk may include the k-th occupancy code OCk and the (k−1)-th motion vector MVk−1.

In detail, according to an embodiment of the present disclosure, the inter prediction frame with respect to the k-th input frame IFMk may be determined as the (k−1)-th overlap frame OFMk−1. In this case, since more detection points may be considered in the inter prediction operation, encoding efficiency of the encoder 100 may be increased.

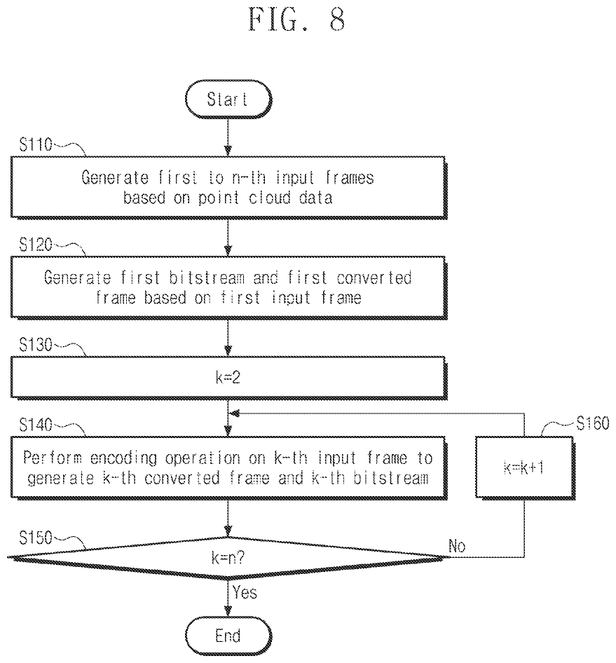

FIG. 8 is a flowchart illustrating an operating method of an encoding device of FIG. 1, according to the embodiment of FIG. 7. Referring to FIGS. 1 to 3 and FIGS. 7 to 8, in operation S110, the encoding device ED may generate the first to n-th input frames IFM1 to IFMn based on the point cloud data PD.

In operation S120, the encoding device ED may generate the first bitstream BS1 and the first converted frame CFM1 based on the first input frame IFM1. Since operation S120 is actually the same as operation S12 described above, additional description thereof will be omitted to avoid redundancy.

In operation S130, the variable ‘k’ may be set to ‘2’. The variable ‘k’ is used to describe that an encoding operation is sequentially performed on the second to n-th input frames IFM2 to IFMn, and does not limit the scope of the present disclosure.

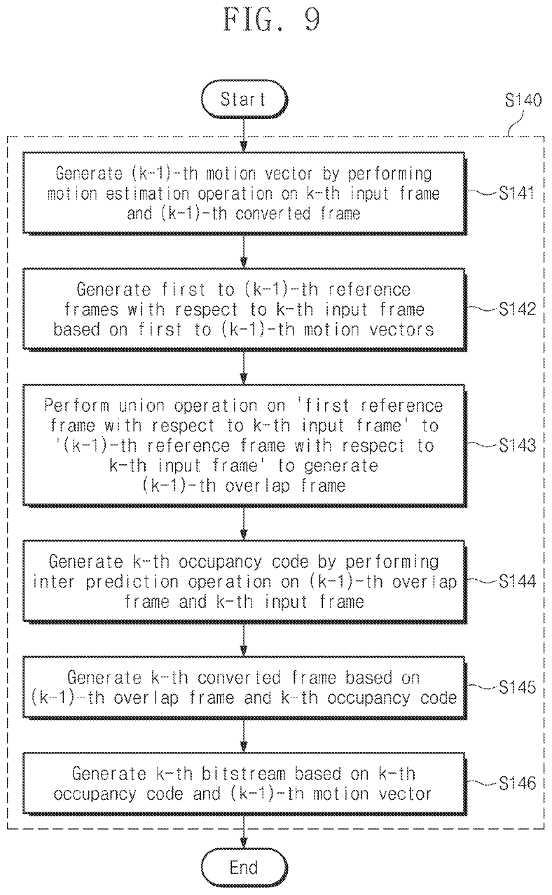

In operation S140, the encoding device ED may perform an encoding operation on the k-th input frame IFMk to generate the k-th converted frame CFMk and the k-th bitstream BSk. In detail, in operation S140, the encoder 100 may perform an encoding operation on the k-th input frame IFMk. The operation of the encoder 100 in operation S140 will be described in more detail with reference to FIG. 9 below.

In operation S150, it is determined whether the value of the variable ‘k’ is ‘n’. When the value of the variable ‘k’ is not ‘n’, operation S160 may be performed, and the variable ‘k’ may be increased by ‘1’. When the value of the variable ‘k’ is ‘n’, the operation of the encoding device 100 may end. In detail, in operation S150, it may be determined whether all input frames included in the same intra period are encoded. In operation S160, the target frame may be changed from the k-th input frame IFMk to the (k+1)-th input frame IFMk+1.

FIG. 9 is a flowchart illustrating an embodiment of operation S140 of FIG. 8. Referring to FIGS. 1 to 3 and 7 to 9, operation S140 may include the following operations S141 to S146.

In operation S141, the encoder 100 may generate the (k−1)-th motion vector MVk−1 by performing a motion estimation operation on the k-th input frame IFMk and the (k−1)-th converted frame CFMk−1. For example, the motion estimation unit 110 may calculate the (k−1)-th motion vector MVk−1 between the k-th input frame IFMk and the (k−1)-th converted frame CFMk−1.

In an embodiment, the (k−1)-th motion vector MVk−1 may be stored in the memory unit 160. For example, when the k-th input frame IFMk is a target frame, the memory unit 160 may store the first motion vector MV1 to the (k−1)-th motion vector MVk−1.

In operation S142, the encoder 100 may generate ‘the first reference frame RFM1_k with respect to the k-th input frame’ to ‘the (k−1)-th reference frame RFMk−1_k with respect to the k-th input frame’ based on the first to (k−1)-th motion vectors MV1 to MVk−1. For example, the motion compensation unit 120 may multiply the coordinates of detection points of the i-th converted frame CFMi (where ‘i’ is an integer greater than or equal to ‘1’ and less than ‘k’) by the i-th to the (k−1)-th motion vectors MVi to MVk−1 to generate ‘i-th reference frame RFMi_k with respect to the k-th input frame’. In this case, the ‘the i-th reference frame RFMi_k with respect to the k-th input frame’ may refer to a result of motion compensation for the i-th converted frame CFMi corresponding to an i-th input frame IFMi based on the k-th input frame IFMk.

In operation S143, the encoder 100 may perform a union operation on ‘the first reference frame RFM1_k with respect to the k-th input frame’ to ‘the (k−1)-th reference frame RFMk−1_k with respect to the k-th input frame’ to generate the (k−1)-th overlap frame OFMk−1. For example, the union operation unit 130 may generate the (k−1)-th overlap frame OFMk−1 through a union operation with respect to the detection points (i.e., motion compensated detection points) included in ‘the first reference frame RFM1_k with respect to the k-th input frame’ to ‘the (k−1)-th reference frame RFMk−1_k with respect to the k-th input frame’.

In operation S144, the encoder 100 may generate the k-th occupancy code OCk by performing an inter prediction operation on the (k−1)-th overlap frame OFMk−1 and the k-th input frame IFMk. For example, the inter prediction unit 140 may perform an inter prediction operation on the (k−1)-th overlap frame OFMk−1 and the k-th input frame IFMk to generate the k-th occupancy code OCk.

In operation S145, the encoder 100 may generate the k-th converted frame CFMk based on the (k−1)-th overlap frame OFMk−1 and the k-th occupancy code OCk. For example, the reconstruction unit 150 may generate the k-th converted frame CFMk based on the (k−1)-th overlap frame OFMk−1 and the k-th occupancy code OCk.

In an embodiment, the k-th converted frame CFMk may be stored in the memory unit 160. For example, when the k-th input frame IFMk is a target frame, the memory unit 160 may store the first to k-th converted frames CFM1 to CFMk. The first to k-th converted frames CFM1 to CFMk stored in the memory unit 160 may be used for an encoding operation with respect to the (k+1)-th input frame IFMk+1.

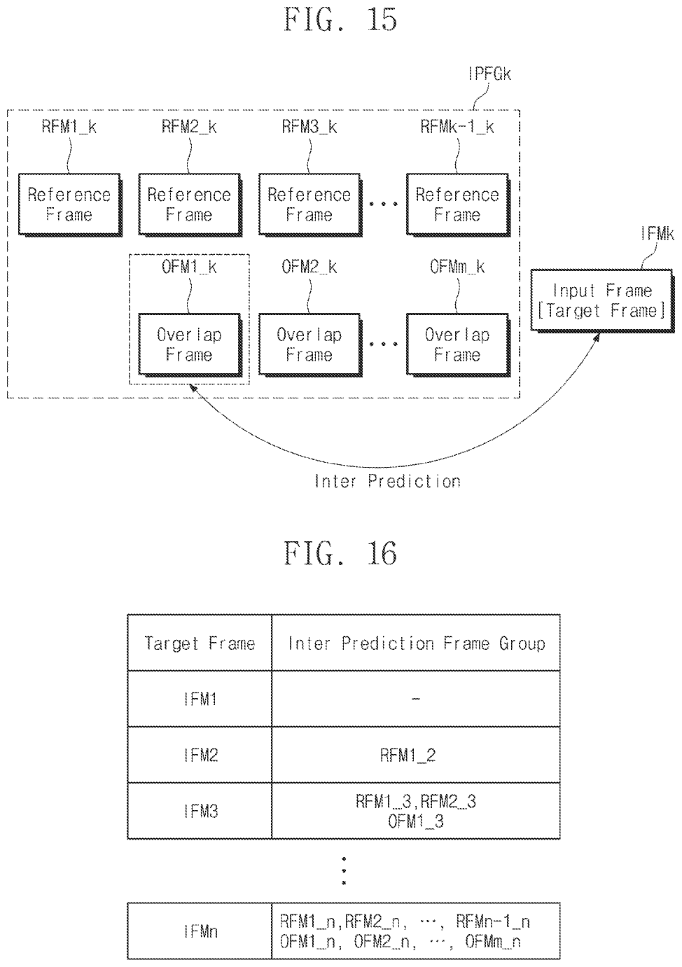

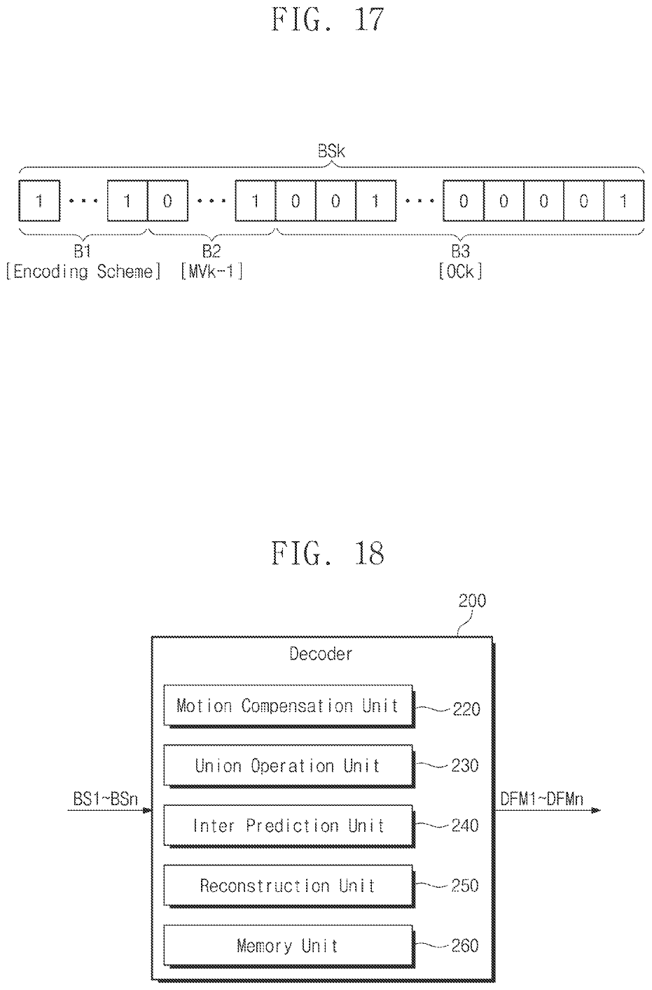

In operation S146, the encoder 100 may generate the k-th bitstream BSk based on the k-th occupancy code OCk and the (k−1)-th motion vector MVk−1. In detail, the k-th bitstream BSk may include the k-th occupancy code OCk and the (k−1)-th motion vector MVk−1. However, the scope of the present disclosure is not limited thereto, and the k-th bitstream BSk may include more diverse information. The configuration of the k-th bitstream BSk will be described in more detail with reference to FIG. 17 below.

FIG. 10 is a diagram illustrating operations S142 to S144 of FIG. 9. Referring to FIGS. 1 to 3 and 7 to 10, the (k−1)-th overlap frame OFMk−1 may be generated through a union operation on ‘the first reference frame RFM1_k with respect to the k-th input frame’ to ‘the (k−1)-th reference frame RFMk−1_k with respect to the k-th input frame’.

The (k−1)-th overlap frame OFMk−1 may be used for an inter prediction operation with the k-th input frame IMFk (i.e., the target frame). In detail, the (k−1)-th overlap frame OFMk−1 may be used as an inter prediction frame with respect to the k-th input frame IMFk.

Each of ‘the first reference frame with respect to the k-th input frame’ (RFM1_k) to ‘the (k−1)-th reference frame with respect to the k-th input frame’ (RFMk−1_k) may be generated by performing a motion compensation with respect to the detection points of the first to k-th converted frames CFM1 to CFMk based on the k-th input frame IFMk.

The (k−1)-th overlap frame OFMk−1 may include the detection points of ‘the first reference frame RFM1_k with respect to the k-th input frame’ to ‘the (k−1)-th reference frame RFMk−1_k with respect to the k-th input frame’. Accordingly, the (k−1)-th overlap frame OFMk−1 may include more detection points than the detection points of each of ‘the first reference frame RFM1_k with respect to the k-th input frame’ to ‘the (k−1)-th reference frame RFMk−1_k with respect to the k-th input frame’. Therefore, according to an embodiment of the present disclosure, since more detection points may be considered for the inter prediction operation, encoding efficiency may be improved.

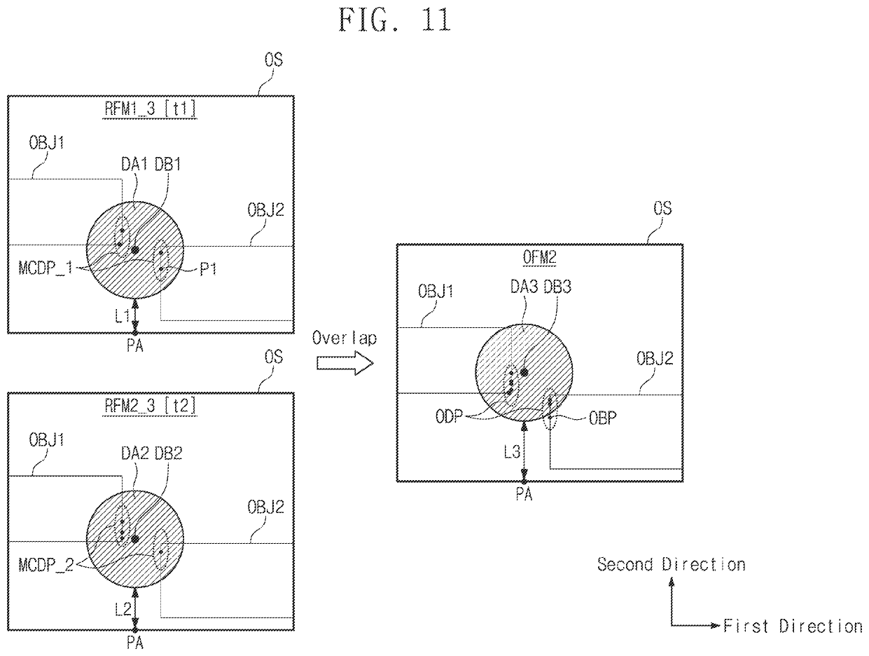

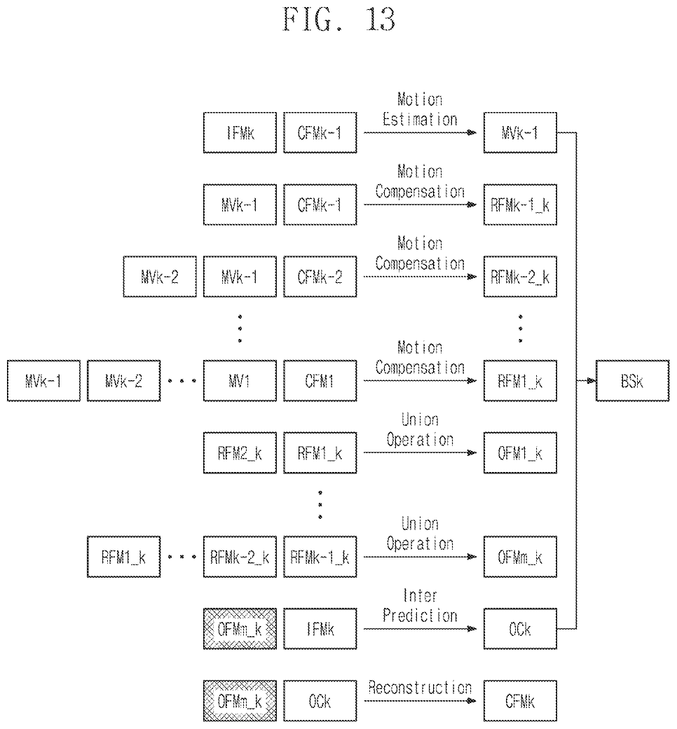

FIG. 11 is a diagram illustrating an operation of the union operation unit of FIG. 3. Hereinafter, with reference to FIGS. 1 to 3 and 7 to 11, an embodiment in which a third input frame IFM3 is a target frame (i.e., ‘k’ is ‘3’) and the second overlap frame OFM2 is generated through a union operation of ‘a first reference frame RFM1_3 with respect to the third input frame’ and ‘a second reference frame RFM2_3 with respect to the third input frame’ will be described as a representative example. However, the scope of the present disclosure is not limited thereto. For example, according to an embodiment of the present disclosure, an overlap frame may be generated through a union operation with respect to two or more reference frames. An embodiment in which an overlap frame is generated through a union operation of two or more reference frames will be described with reference to FIGS. 13 to 16 below.

Referring continuously to FIG. 11, ‘the first reference frame RFM1_3 with respect to the third input frame’ may correspond to the first input frame IFM1. For example, like the first input frame IFM1, ‘the first reference frame RFM1_3 with respect to the third input frame’ may include the detection points corresponding to information of the first time t1 of the point cloud data PC. As in the above description, ‘the second reference frame RFM2_3 with respect to the third input frame’ may correspond to the second input frame IFM2 and may include the detection points corresponding to information of a second time t2 of the point cloud data PC.

In an embodiment, the LiDAR device may move in time series. The LiDAR device may move in an operating area OS. In this case, the detection bull corresponding to the physical location of the LiDAR device may also move in time series. For example, the LiDAR device may be disposed at a first detection bull DB1 at the first time t1, may be disposed at a second detection bull DB2 at the second time t2, and may be disposed at a third detection bull DB3 at a third time t3.

In an embodiment, based on the detection bull, an area within a specific distance may be set as the detection area of the LiDAR device. In this case, the detection area may move in time series in the operating area OS. For example, a first detection area DA1 at the first time t1 may be located away from a starting point PA on the operating area OS by ‘L1’ in a second direction. A second detection area DA2 at the second time t2 may be located away from the starting point PA on the operating area OS by ‘L2’ in the second direction. In addition, a third detection area DA3 at the third time t3 may be located away from the starting point PA on the operation area OS by ‘L3’ in the second direction.

A first object OBJ1 and a second object OBJ2 may be included in the operating area OS. The LiDAR device may detect objects within the first detection area DA1 when the LiDAR device is disposed in the first detection bull DB1 at the first time t1. In this case, the points detected by the LiDAR device at the first time t1 may correspond to the first detection points included in the first input frame IFM1. As in the above description, the points detected by the LiDAR device at the second time t2 may correspond to the second detection points included in the second input frame IFM2.

The ‘first reference frame RFM1_3 with respect to the third input frame’ may include first motion compensation detection points MCDP_1 corresponding to the first detection points. In this case, the first motion compensation detection points MCDP_1 may be included in the first detection area DAL.

The ‘second reference frame RFM2_3 with respect to the third input frame’ may include second motion compensation detection points MCDP_2 corresponding to the second detection points. In this case, the second motion compensation detection points MCDP_2 may be included in the second detection area DA2.

The second overlap frame OFM2 may be generated through a union operation on the first motion compensation detection points MCDP_1 and the second motion compensation detection points MCDP_2. For example, the second overlap frame OFM2 may include overlap detection points ODP. The overlap detection points ODP may be determined as a union of the first motion compensation detection points MCDP_1 and the second motion compensation detection points MCDP_2. In detail, the overlap detection points ODP may include the first motion compensation detection points MCDP_1 and the second motion compensation detection points MCDP_2.

In an embodiment, the first motion compensation detection points MCDP_1 and the first detection points in the first input frame IFM1 may correspond to the same object in the operating space OS. As in the above description, the second motion compensation detection points MCDP_2 and the second detection points in the second input frame IFM2 may correspond to the same object in the operating space OS.

In an embodiment, the first motion compensation detection points MCDP_1 may include a first point P1. The first point P1 is included in the first detection area DA1 but may not be included in the third detection area DA3. For example, when the detection distance of the LiDAR device is set to 5 meters from the detection bull, the distance between the first point P1 and the first detection bull DB1 may be 5 meters or less, and the distance between the first point P1 and the third detection bull DB3 may be 5 meters or more. Accordingly, the first point P1 may be referred to as an out bound point OBP with respect to the third detection area DA3. In this case, the overlap detection points ODP may not include the out bound point OBP. However, the scope of the present disclosure is not limited thereto.

In detail, according to an embodiment of the present disclosure, an overlap frame may be generated through a union operation with respect to the detection points included in different reference frames. In this case, the overlap frame may include more detection points (i.e., overlap detection points) than a single reference frame. Therefore, when the inter prediction operation is performed on the overlap frame and the target frame, compression efficiency on the target frame may be improved.

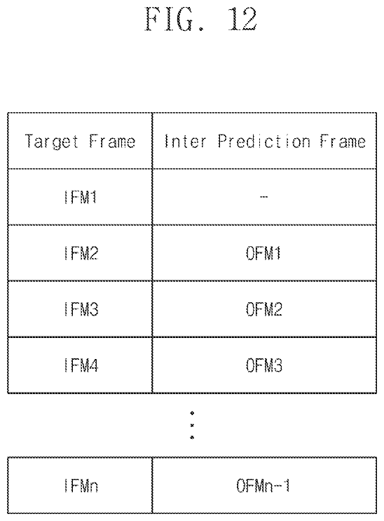

FIG. 12 is a table illustrating a target frame and an inter prediction frame, according to an embodiment of FIG. 9. Referring to FIGS. 1 to 3 and 7 to 11, the inter prediction unit 140 may perform an inter prediction operation based on the target frame and the inter prediction frame.

When the k-th input frame IFMk is the target frame, the inter prediction unit 140 may perform an inter prediction operation based on the (k−1)-th overlap frame OFMk−1. For example, when the second input frame IFM2 is the target frame, the inter prediction unit 140 may perform an inter prediction operation based on the first overlap frame OFM1.

FIG. 13 is a diagram illustrating an operation of an encoder of FIG. 3, according to another embodiment of the present disclosure. Encoding operations for the second to n-th input frames IFM2 to IFMn will be described with reference to FIGS. 1 to 3, 8, and 13. For example, in FIG. 13, an embodiment of a case where the k-th input frame IFMk (i.e., ‘k’ may be an integer greater than 2) among the second to n-th input frames IFM2 to IFMn is a target frame will be representatively described. Since the encoding operation for the first input frame IFM1 is similar to that described above with reference to FIG. 3, additional description thereof will be omitted to avoid redundancy.

Continuing to refer to FIG. 13, the encoder 100 may receive the k-th input frame IFMk. The motion estimation unit 110 may perform a motion estimation operation based on the k-th input frame IFMk and the (k−1)-th converted frame CFMk−1. In detail, the motion estimation unit 110 may generate the (k−1)-th motion vector MVk−1 based on the k-th input frame IFMk and the (k−1)-th converted frame CFMk−1.

The motion compensation unit 120 may perform a motion compensation operation on the first to (k−1)-th converted frames CFM1 to CFMk−1 based on the first to (k−1)-th motion vectors MV1 to MVk−1 to generate ‘the first reference frame RFM1_k with respect to the k-th input frame’ to ‘the (k−1)-th reference frame RFMk−1_k with respect to the k-th input frame’. An operation of the motion compensation unit 120 is similar to that described above with reference to FIG. 7, and thus, additional description thereof will be omitted to avoid redundancy.

The union operation unit 130 may perform a union operation on any combination of ‘the first reference frame RFM1_k with respect to the k-th input frame’ to ‘the (k−1)-th reference frame RFMk−1_k with respect to the k-th input frame’ to generate overlap frames. For example, the union operation unit 130 may generate ‘a first overlap frame OFM1_k with respect to the k-th input frame’ to ‘an m-th overlap frame OFMm_k with respect to the k-th input frame’ based on any combination of ‘the first reference frame RFM1_k with respect to the k-th input frame’ to ‘the (k−1)-th reference frame RFMk−1_k with respect to the k-th input frame’.

Each of ‘the first overlap frame OFM1_k with respect to the k-th input frame’ to ‘the m-th overlap frame OFMm_k with respect to the k-th input frame’ may be generated through a union operation of arbitrary combinations of ‘the first reference frame RFM1_k with respect to the k-th input frame’ to ‘the (k−1)-th reference frame RFMk−1_k with respect to the k-th input frame’. For example, ‘the first overlap frame OFM1_k with respect to the k-th input frame’ may be generated through a union operation of ‘the first reference frame RFM1_k with respect to the k-th input frame’ and ‘the second reference frame RFM2_k with respect to the k-th input frame’. The ‘m-th overlap frame OFMm_k with respect to the k-th input frame’ may be generated through a union operation of all of ‘the first reference frame RFM1_k with respect to the k-th input frame’ to ‘the (k−1)-th reference frame RFMk−1_k with respect to the k-th input frame’. However, the scope of the present disclosure is not limited to the combination of reference frames described above.

In an embodiment, ‘the first reference frame RFM1_k with respect to the k-th input frame’ to ‘the (k−1)-th reference frame RFMk−1_k with respect to the k-th input frame’, and ‘the first overlap frame OFM1_k with respect to the k-th input frame’ to ‘the m-th overlap frame OFMm_k with respect to the k-th input frame’ may be included in a inter prediction frame group. The inter prediction frame group may refer to a set of candidate frames in which an inter prediction operation with a target frame is to be performed. The inter prediction frame group may be stored in the memory unit 160.

The inter prediction unit 140 may select one of ‘the first reference frame RFM1_k with respect to the k-th input frame’ to ‘the (k−1)-th reference frame RFMk−1_k with respect to the k-th input frame’ or ‘the first overlap frame OFM1_k with respect to the k-th input frame’ to ‘the m-th overlap frame OFMm_k with respect to the k-th input frame’ as the inter prediction frame. In detail, the inter prediction unit 140 may perform an inter prediction operation on the selected frame (illustrated as hatched) and the k-th input frame IFMk (i.e., the target frame) to generate the k-th occupancy code OCk.

In an embodiment, the selected frame may be a frame most similar to the target frame among frames in the inter prediction frame group.

In an embodiment, the encoder 100 may measure encoding performance for each of frames (e.g., reference frames and overlap frames) in the inter prediction frame group. In this case, the encoder 100 may select a frame having the highest encoding performance as the inter prediction frame in the inter prediction frame group. In detail, according to an embodiment of the present disclosure, a frame having the highest coding performance among frames in the inter prediction frame group may be selected as the inter prediction frame.

The reconstruction unit 150 may generate the k-th converted frame CFMk based on the selected frame (illustrated with hatched lines) and the k-th occupancy code OCk. Since the k-th converted frame CFMk is similar to that described above with reference to FIG. 7, additional description thereof will be omitted to avoid redundancy.

The encoder 100 may generate the k-th bitstream BSk based on the k-th input frame IFMk. In this case, the k-th bitstream BSk may include the k-th occupancy code OCk and the (k−1)-th motion vector MVk−1.

In an embodiment, the k-th bitstream BSk may further include a bit area indicating information on the selected frame.

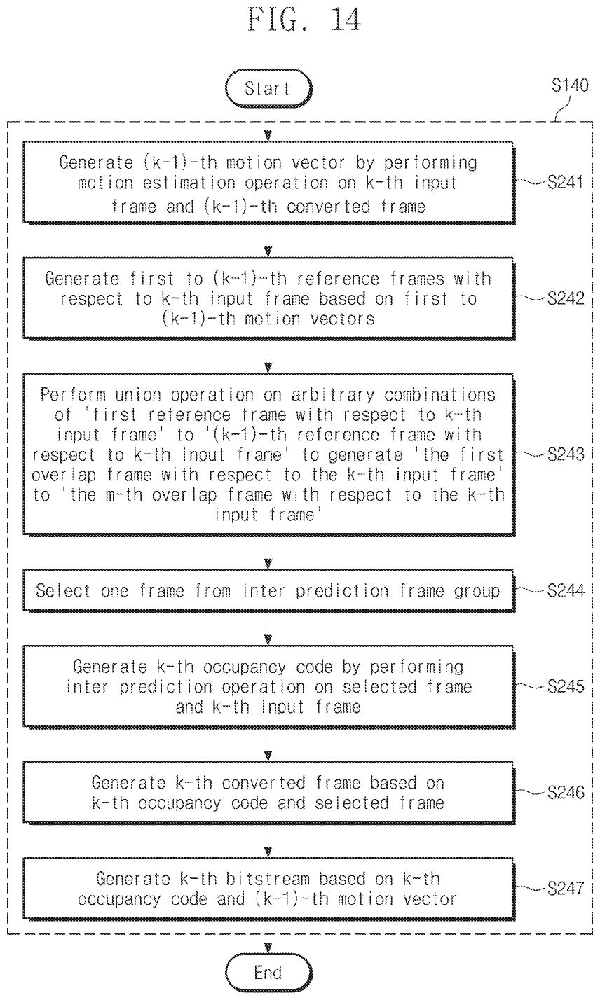

FIG. 14 is a flowchart illustrating another embodiment of operation S140 of FIG. 8, according to an embodiment of FIG. 13. Referring to FIGS. 1 to 3, 8, 13, and 14, operation S140 may include the following operation S241 to S247. Operations S241 and S242 are similar to operations S141 and S142 previously described with reference to FIG. 9, so additional description thereof is omitted to avoid redundancy.

In an embodiment, the reference frames generated in operation S242 may be stored in an inter prediction frame group.

In operation S243, the encoder 100 may perform a union operation on arbitrary combinations of ‘the first reference frame RFM1_k with respect to the k-th input frame’ to ‘the (k−1)-th reference frame RFMk−1_k with respect to the k-th input frame’ to generate ‘the first overlap frame OFM1_k with respect to the k-th input frame’ to ‘the m-th overlap frame OFMm_k with respect to the k-th input frame’. In detail, ‘the first overlap frame OFM1_k with respect to the k-th input frame’ to ‘the m-th overlap frame OFMm_k with respect to the k-th input frame’ may be generated based on different arbitrary combinations of reference frames.

In an embodiment, overlap frames generated in operation S243 may be stored in the inter prediction frame group.

In operation S244, the encoder 100 may select one frame from the inter prediction frame group. In detail, the encoder 100 may select one of ‘the first reference frame RFM1_k with respect to the k-th input frame’ to ‘the (k−1)-th reference frame RFMk−1_k with respect to the k-th input frame’, and ‘the first overlap frame OFM1_k with respect to the k-th input frame’ to ‘the m-th overlap frame OFMm_k with respect to the k-th input frame’.

In operation S245, the encoder 100 may generate the k-th occupancy code OCk by performing an inter prediction operation on the selected frame and the k-th input frame IFMk. For example, the inter prediction unit 140 may generate the k-th occupancy code OCk by performing an inter prediction operation on the selected frame and the k-th input frame IFMk.

In operation S246, the encoder 100 may generate the k-th converted frame CFMk based on the k-th occupancy code OCk and the selected frame.

In operation S247, the encoder 100 may generate the k-th bitstream BSk based on the k-th occupancy code OCk and the (k−1)-th motion vector MVk−1. In detail, the k-th bitstream BSk may include the k-th occupancy code OCk and the (k−1)-th motion vector MVk−1. In addition, the k-th bitstream BSk may further include a bit area indicating the frame selected in operation S244 and a bit area indicating reference frames used for combining the selected frames.

FIG. 15 is a diagram illustrating operations S242 to S245 of FIG. 14.

Referring to FIGS. 1 to 3, 8, and 13 to 15, a k-th inter prediction frame group IPFGk, which is an inter prediction frame group when the k-th input frame IFMk is a target frame, is illustrated. The k-th inter prediction frame group IPFGk may include ‘the first reference frame RFM1_k with respect to the k-th input frame’ to ‘the (k−1)-th reference frame RFMk−1_k with respect to the k-th input frame’. The k-th inter prediction frame group IPFGk may also include ‘the first overlap frame OFM1_k with respect to the k-th input frame’ to ‘the m-th overlap frame OFMm_k with respect to the k-th input frame’.

The inter prediction unit 140 may perform an inter prediction operation with the k-th input frame IFMk by selecting one of the frames in the k-th inter prediction frame group IPFGk. For convenience of description, among the frames in the k-th inter prediction frame group IPFGk, a frame in which an inter prediction operation with the k-th input frame IFMk is performed will be referred to as a k-th inter prediction frame.

FIG. 16 is a table illustrating a target frame and an inter prediction frame group, according to an embodiment of FIG. 13. Referring to FIGS. 1 to 3, 8, and 13 to 16, the inter prediction unit 140 may perform an inter prediction operation based on the target frame and the inter prediction frame.

When the k-th input frame IFMk is the target frame, the inter prediction unit 140 may perform an inter prediction operation by selecting one of the frames in the k-th inter prediction frame group IPFGk.

FIG. 17 is a diagram illustrating a configuration of a bitstream, according to an embodiment of the present disclosure. Referring to FIGS. 1 to 17, the k-th bitstream BSk may include first to third bit areas B1 to B3.

The first bit area B1 may indicate that an encoding scheme according to an embodiment of the present disclosure is applied. For example, the first bit area B1 may be a flag bit indicating an encoding scheme.

The second bit area B2 may include the (k−1)-th motion vector MVk−1.

The third bit area B3 may include the k-th occupancy code OCk.

In an embodiment, the k-th bitstream BSk may further include a fourth bit area indicating the selected frame and reference frames used for combining the selected frames.

For a convenience of description, although the first to third bit areas B1 to B3 are sequentially arranged in the k-th bitstream BSk in FIG. 17, the scope of the present disclosure is not limited thereto. For example, in the k-th bitstream BSk, the first to third bit areas B1 to B3 may be arranged in a different order, and some of the first to third bit areas B1 to B3 may be omitted. In addition, the first to third bit areas B1 to B3 may be encoded using various encoding schemes (e.g., arithmetic encoding).

FIG. 18 is a diagram illustrating a decoder, according to an embodiment of the present disclosure. Referring to FIG. 18, a decoder 200 may include a motion compensation unit 220, a union operation unit 230, an inter prediction unit 240, a reconstruction unit 250, and a memory unit 260. The decoder 200 may receive the first to n-th bitstreams BS1 to BSn and may generate first to n-th decoded frames DFM1 to DFMn.

In an embodiment, the first to n-th decoded frames DFM1 to DFMn may be the same as the first to n-th converted frames CFM1 to CFMn described above with reference to FIGS. 7 to 12.

Hereinafter, for a convenience of description, an embodiment in which the decoder 200 performs a decoding operation on bitstreams encoded by the encoding scheme described with reference to FIGS. 7 to 12 will be described as a representative example. However, the scope of the present disclosure is not limited thereto, and the decoder 200 may perform a decoding operation on bitstreams encoded by the encoding scheme described with reference to FIGS. 13 to 16.

The functions of the motion compensation unit 220, the union operation unit 230, the inter prediction unit 240, the reconstruction unit 250, and the memory unit 260 are similar to that of the motion compensation unit 120, the union operation unit 130, the inter prediction unit 140, the reconstruction unit 150, and the memory unit 160 described above with reference to FIG. 3, and thus, additional descriptions will be omitted to avoid redundancy.

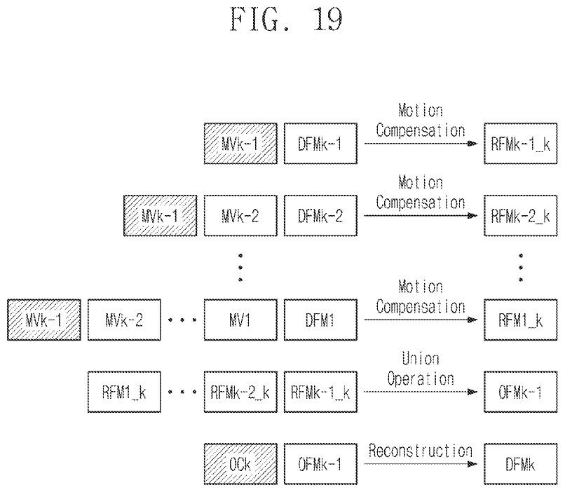

The decoder 200 may sequentially perform a decoding operation on the first to n-th bitstreams BS1 to BSn. For example, the decoder 200 may perform a decoding operation on the first bitstream BS1 to generate the first occupancy code OC1 and a first decoded frame DFM1. A decoding operation with respect to the second to n-th bitstreams BS1 to BSn will be described in detail with reference to FIGS. 19 to 23 below.

FIG. 19 is a diagram illustrating an operation of a decoder of FIG. 18, according to an embodiment of the present disclosure. With reference to FIGS. 18 and 19, decoding operations with respect to the second to n-th bitstreams BS2 to BSn will be described. For example, in FIG. 19, an embodiment of a case where a decoding operation is performed on the k-th bitstream BSk (where ‘k’ may be an integer greater than ‘2’) among the second to n-th bitstreams BS2 to BSn is representatively described. A decoding operation for the first bitstream BS1 is similar to that described above with reference to FIG. 18, and thus, additional description thereof will be omitted to avoid redundancy.

Continuing to refer to FIG. 19, the decoder 200 may receive the k-th bitstream BSk. The decoder 200 may generate the (k−1)-th motion vector MVk−1 and the k-th occupancy code OCk from the k-th bitstream BSk. In detail, the decoder 200 may restore components illustrated in hatched lines in FIG. 19 from the k-th bitstream BSk.

The decoder 200 may store the (k−1)-th motion vector MVk−1 in the memory unit 260. For example, when a decoding operation is performed on the k-th bitstream BSk, the memory unit 160 may store the first motion vector MV1 to the (k−1)-th motion vector MVk−1.

The motion compensation unit 220 may perform a motion compensation operation on first to (k−1)-th decoded frames DFM1 to DFMk−1 based on the first to (k−1)-th motion vectors MV1 to MVk−1. In detail, the motion compensation unit 220 may generate ‘the first reference frame RFM1_k with respect to the k-th bitstream’ to ‘the (k−1)-th reference frame RFMk−1_k with respect to the k-th bitstream’. An operation of the motion compensation unit 220 is similar to that of the motion compensation unit 120 described with reference to FIG. 7, and thus, additional description thereof will be omitted to avoid redundancy.

In an embodiment, ‘the first reference frame RFM1_k with respect to the k-th bitstream’ to ‘the (k−1)-th reference frame RFMk−1_k with respect to the k-th bitstream’ may be the same as ‘the first reference frame RFM1_k with respect to the k-th input frame’ to ‘(k−1)-th reference frame RFMk−1_k with respect to the k-th input frame’ described above with reference to FIGS. 7 to 12 respectively.

The union operation unit 230 may perform a union operation on ‘the first reference frame RFM1_k with respect to the k-th bitstream’ to ‘the (k−1)-th reference frame RFMk−1_k with respect to the k-th bitstream’ to generate the (k−1)-th overlap frame OFMk−1. The operation of the union operation unit 230 is similar to that of the union operation unit 130 described above with reference to FIG. 7, and thus, additional description thereof will be omitted to avoid redundancy.

The reconstruction unit 250 may generate a k-th decoded frame DFMk based on the (k−1)-th overlap frame OFMk−1 and the k-th occupancy code OCk.

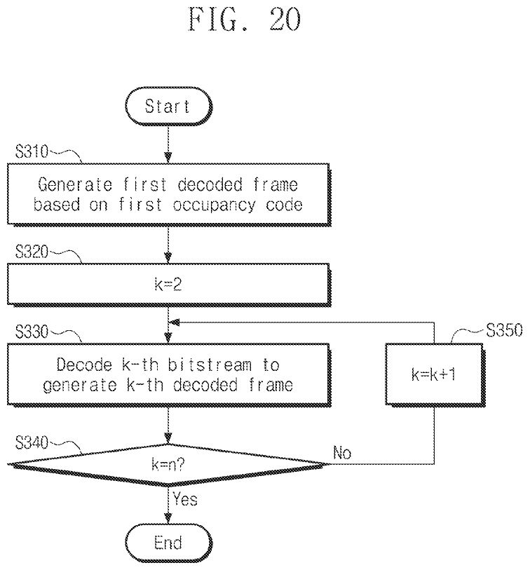

FIG. 20 is a flowchart illustrating an operating method of a decoding device of FIG. 18, according to an embodiment of FIG. 19. Referring to FIGS. 18 to 20, in operation S310, the decoder 200 may generate the first decoded frame DFM1 based on the first occupancy code OC1. In detail, the decoder 200 may generate the first decoded frame DFM1 based on the first occupancy code OC1 included in the first bitstream BS1.

In operation S320, the variable ‘k’ may be set to ‘2’. The variable ‘k’ is used to describe that decoding operations are performed sequentially with respect to the second to n-th bitstreams BS2 to BSn, and does not limit the scope of the present disclosure.

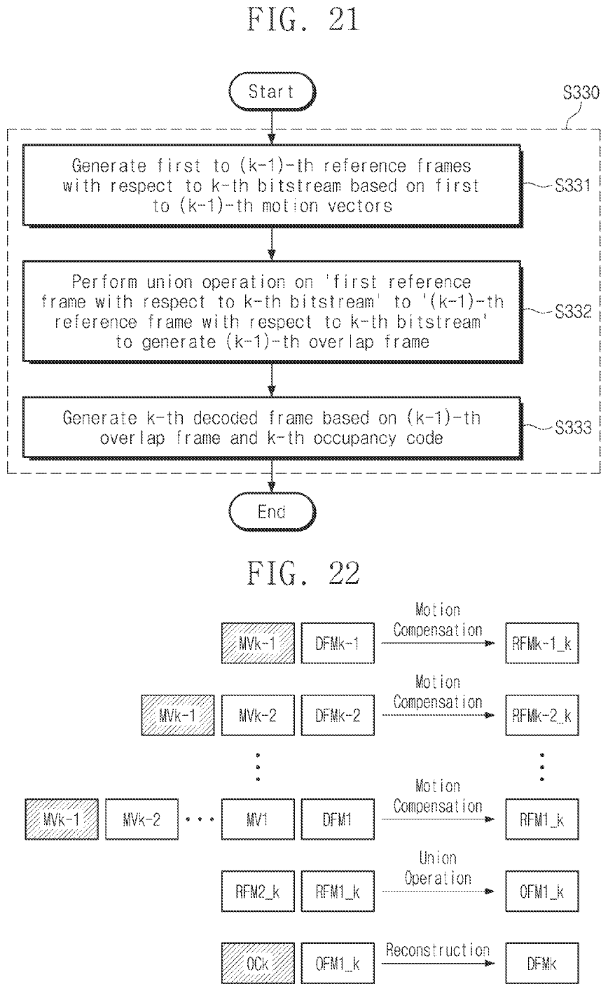

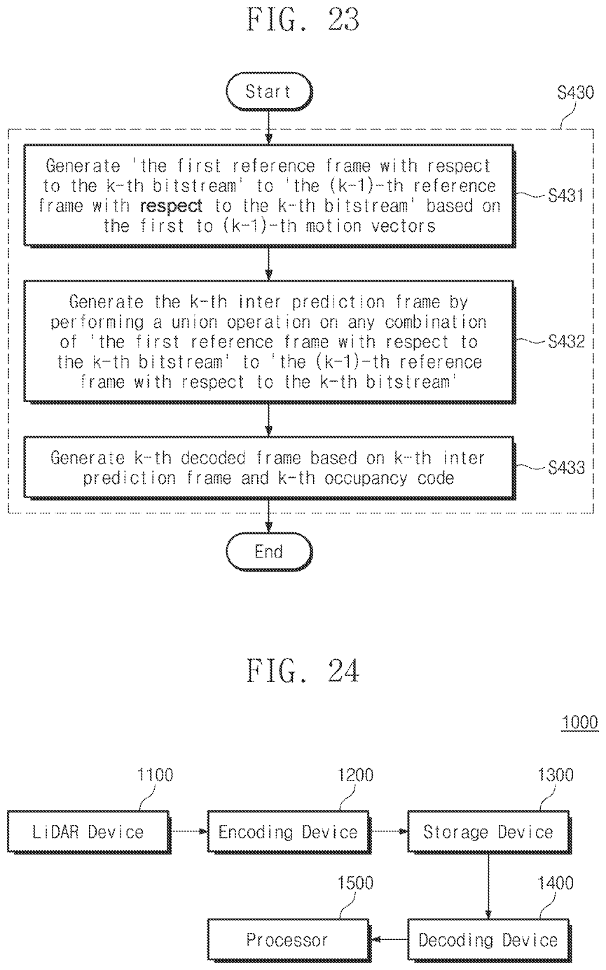

In operation S330, the decoder 200 may decode the k-th bitstream BSk to generate the k-th decoded frame DFMk. For example, the decoder 200 may generate the k-th decoded frame DFMk based on the (k−1)-th motion vector MVk−1 and the k-th occupancy code OCk included in the k-th bitstream BSk. The operation of the decoder 200 in operation S330 will be described in detail with reference to FIGS. 21 and 23 below.

In operation S340, it is determined whether the value of the variable ‘k’ is ‘n’. When the value of the variable ‘k’ is not ‘n’, operation S350 may be performed, and the variable ‘k’ may be increased by ‘1’. When the value of the variable ‘k’ is ‘n’, the operation of the decoder 200 may end. In detail, in operation S340, it may be determined whether all bitstreams corresponding to the same intra period are decoded. In operation S350, the bitstream to be decoded may be changed from the k-th bitstream BSk to a (k+1)-th bitstream BSk+1.

FIG. 21 is a flowchart illustrating operation S330 of FIG. 20 in more detail. Referring to FIGS. 18 to 21, operation S330 may include the following operations S331 to S333.

In operation S331, the decoder 200 may generate ‘the first reference frame RFM1_k with respect to the k-th bitstream’ to ‘the (k−1)-th reference frame RFMk−1_k with respect to the k-th bitstream’ based on the first to (k−1)-th motion vectors MV1 to MVk−1. Operation S331 is similar to operation S142 described above with reference to FIG. 9, and thus, additional description thereof will be omitted to avoid redundancy.

In operation S332, the decoder 200 may perform a union operation on ‘the first reference frame RFM1_k with respect to the k-th bitstream’ to ‘the (k−1)-th reference frame RFMk−1_k with respect to the k-th bitstream’ to generate the (k−1)-th overlap frame OFMk−1. Operation S332 is similar to operation S143 described above with reference to FIG. 9, and thus, additional description thereof will be omitted to avoid redundancy.

In operation S333, the decoder 200 may generate the k-th decoded frame DFMk based on the (k−1)-th overlap frame OFMk−1 and the k-th occupancy code OCk. Operation S333 is similar to operation S145 described above with reference to FIG. 9, and thus, additional description thereof will be omitted to avoid redundancy.

FIG. 22 is a diagram illustrating an operation of a decoder of FIG. 18, according to another embodiment of the present disclosure. With reference to FIGS. 18 and 22, decoding operations for the second to n-th bitstreams BS2 to BSn encoded with the manner described with reference to FIGS. 13 to 16 will be described. For example, in FIG. 22, an embodiment of a case where a decoding operation is performed on the k-th bitstream BSk (where ‘k’ may be an integer greater than ‘2’) among the second to n-th bitstreams BS2 to BSn is representatively described. A decoding operation for the first bitstream BS1 is similar to that described above with reference to FIG. 18, and thus, additional description thereof will be omitted to avoid redundancy.

Continuing to refer to FIG. 22, the decoder 200 may receive the k-th bitstream BSk. The decoder 200 may generate the (k−1)-th motion vector MVk−1 and the k-th occupancy code OCk from the k-th bitstream BSk. In detail, the decoder 200 may restore components illustrated in hatched lines in FIG. 22 from the k-th bitstream BSk.

The decoder 200 may store the (k−1)-th motion vector MVk−1 in the memory unit 260. For example, when a decoding operation is performed on the k-th bitstream BSk, the memory unit 260 may store the first motion vector MV1 to the (k−1)-th motion vector MVk−1.

The motion compensation unit 220 may perform a motion compensation operation on first to (k−1)-th decoded frames DFM1 to DFMk−1 based on the first to (k−1)-th motion vectors MV1 to MVk−1. In detail, the motion compensation unit 220 may generate ‘the first reference frame RFM1_k with respect to the k-th bitstream’ to ‘the (k−1)-th reference frame RFMk−1_k with respect to the k-th bitstream’.

In an embodiment, ‘the first reference frame RFM1_k with respect to the k-th bitstream’ to ‘the (k−1)-th reference frame RFMk−1_k with respect to the k-th bitstream’ may be the same as ‘the first reference frame RFM1_k with respect to the k-th input frame’ to ‘(k−1)-th reference frame RFMk−1_k with respect to the k-th input frame’ described above with reference to FIGS. 7 to 12 respectively.

The union operation unit 230 may perform a union operation on any combination of ‘the first reference frame RFM1_k with respect to the k-th bitstream’ to ‘the (k−1)-th reference frame RFMk−1_k with respect to the k-th bitstream’ to generate the inter prediction frame. For example, when the first overlap frame OFM1_k illustrated in FIGS. 13 to 16 is an inter prediction frame with respect to the k-th input frame IFMk, the union operation unit 230 may perform a union operation on ‘the first reference frame RFM1_k with respect to the k-th bitstream’ and ‘the second reference frame RFM2_k with respect to the k-th bitstream’ to generate the first overlap frame OFM1_k.

In detail, in FIG. 22, an embodiment in which the first overlap frame OFM1_k is an inter prediction frame is representatively illustrated. However, the scope of the present disclosure is not limited thereto, and any frame among the inter prediction frame groups illustrated in FIGS. 15 and 16 may be the inter prediction frame. In this case, to generate the inter prediction frame, the union operation unit 230 will be able to perform a union operation on any combination of ‘the first reference frame RFM1_k with respect to the k-th bitstream’ to ‘the (k−1)-th reference frame RFMk−1_k with respect to the k-th bitstream’.

In an embodiment, the k-th bitstream BSk may include a bit area indicating information on the selected frame. In this case, the union operation unit 230 will be able to perform a union operation on any combination of ‘the first reference frame RFM1_k with respect to the k-th bitstream’ to ‘the (k−1)-th reference frame RFMk−1_k with respect to the k-th bitstream’ with reference to the bit area.

The reconstruction unit 250 may generate the k-th decoded frame DFMk based on the inter prediction frame and the k-th occupancy code OCk. For example, the reconstruction unit 250 may generate the k-th decoded frame DFMk based on the first overlap frame OFM1_k and the k-th occupancy code OCk.

FIG. 23 is a flowchart illustrating another embodiment of operation S330 of FIG. 20, according to an embodiment of FIG. 22. Referring to FIGS. 18, 20, and 22 to 23, operation S330 may include the following operations S431 to S433.

In operation S431, the decoder 200 may generate ‘the first reference frame RFM1_k with respect to the k-th bitstream’ to ‘the (k−1)-th reference frame RFMk−1_k with respect to the k-th bitstream’ based on the first to (k−1)-th motion vectors MV1 to MVk−1. Operation S431 is similar to operation S331 described above with reference to FIG. 21, and thus, additional description thereof will be omitted to avoid redundancy.

In operation S432, the decoder 200 may perform a union operation on any combination of ‘the first reference frame RFM1_k with respect to the k-th bitstream’ to ‘the (k−1)-th reference frame RFMk−1_k with respect to the k-th bitstream’ to generate the k-th inter prediction frame. For example, the decoder 200 may generate the k-th inter prediction frame by referring to information on ‘reference frames used in a union operation for generating an inter prediction frame’ included in the k-th bitstream BSk.

In operation S433, the decoder 200 may generate the k-th decoded frame DFMk based on the k-th inter prediction frame and the k-th occupancy code OCk.

FIG. 24 is a block diagram illustrating a LiDAR system, according to an embodiment of the present disclosure. Referring to FIG. 24, a LiDAR system 1000 may include a LiDAR device 1100, an encoding device 1200, a storage device 1300, a decoding device 1400, and a processor 1500.

The LiDAR device 1100 may include a plurality of LiDAR sensors. The LiDAR device 1100 may collect 3D point cloud data through a plurality of LiDAR sensors.

The encoding device 1200 may receive the 3D point cloud data from the LiDAR device 1100. The encoding device 1200 may convert the 3D point cloud data into a bitstream by performing the encoding. In an embodiment, the encoding device 1200 may be implemented in a manner similar to the encoder 100 described with reference to FIGS. 1 to 17. For example, the encoding device 1200 may convert the 3D point cloud data into a plurality of frames included in a single intra period.

The storage device 1300 may receive and store the bitstream from the encoding device 1200. For example, the storage device 1300 may include a volatile memory device such as a static random access memory (SRAM) and a dynamic random access memory (DRAM), or a nonvolatile memory device such as a flash memory, a phase-change random access memory (PRAM), a magnetic random access memory (MRAM), a resistive random access memory (ReRAM), and a ferroelectric random access memory (FRAM).

The decoding device 1400 may read the bitstream from the storage device and may decode the bitstream into 3D point cloud data. In an embodiment, the decoding device 1400 may be implemented in a manner similar to the decoder 200 described with reference to FIGS. 18 to 21.

The processor 1500 may receive the 3D point cloud data from the decoding device 1400. The processor 1500 may process operations requested by various application programs that use the 3D point cloud data.

The above description refers to embodiments for implementing the present disclosure. Embodiments in which a design is changed simply or which are easily changed may be included in the present disclosure as well as the embodiments described above. In addition, technologies that are easily changed and implemented by using the above embodiments may be included in the present disclosure. While the present disclosure has been described with reference to exemplary embodiments thereof, it will be apparent to those of ordinary skill in the art that various changes and modifications may be made thereto without departing from the spirit and scope of the present disclosure as set forth in the following claims.

What is claimed is:

1. An encoder which receives first to third input frames included in a first intra period and outputs a bitstream corresponding to the third input frame, the encoder comprising:
a motion compensation unit configured to generate a first reference frame corresponding to the first input frame and a second reference frame corresponding to the second input frame;
a union operation unit configured to generate an overlap frame by performing a union operation based on the first reference frame and the second reference frame; and
an inter prediction unit configured to generate an occupancy code by performing an inter prediction operation on the overlap frame and the third input frame, and
wherein the bitstream includes the occupancy code.

2. The encoder of claim 1, wherein the first to third input frames correspond to first to third time information of point cloud data collected by a LiDAR device outside the encoder, respectively.

3. The encoder of claim 2, wherein the first input frame includes first detection points with respect to objects, the second input frame includes second detection points with respect to the objects, and the third input frame includes third detection points with respect to the objects.

4. The encoder of claim 3, wherein the first reference frame includes first motion compensation detection points corresponding to the first detection points, and
wherein the second reference frame includes second motion compensation detection points corresponding to the second detection points.

5. The encoder of claim 4, wherein the overlap frame includes the first motion compensation detection points and the second motion compensation detection points.

6. The encoder of claim 4, wherein the first detection points are included in a first detection area of the LiDAR device at the first time, the second detection points are included in a second detection area of the LiDAR device at the second time, and the third detection points are included in a third detection area of the LiDAR device at the third time, and
wherein the overlap frame includes:
motion compensation detection points included in the third detection area among the first motion compensation detection points and the second motion compensation detection points.

7. The encoder of claim 6, wherein the overlap frame does not include a motion compensation detection point which is not included in the third detection area among the first motion compensation detection points and the second motion compensation detection points.

8. The encoder of claim 1, wherein the union operation is:
performed with respect to any combination of a plurality of reference frames including the first reference frame and the second reference frame.

9. The encoder of claim 8, wherein the bitstream includes:
a bit area indicating reference frames used in the union operation among the plurality of reference frames.

10. A method of operating an encoder which encodes first to n-th input frames to generate first to n-th bitstreams, the method comprising:
generating a first converted frame and the first bitstream based on the first input frame; and
sequentially performing an encoding operation on the second to n-th input frames to generate the second to n-th bitstreams, respectively, and
wherein the encoding operation with respect to a k-th input frame among the second to n-th input frames includes:
generating a (k−1)-th motion vector by performing a motion estimation operation on the k-th input frame and a (k−1)-th converted frame;
generating first to (k−1)-th reference frames with respect to the k-th input frame based on first to the (k−1)-th motion vectors;
generating a (k−1)-th overlap frame by performing a union operation on the first to (k−1)-th reference frames with respect to the k-th input frame;
generating a k-th occupancy code by performing an inter prediction operation on the (k−1)-th overlap frame and the k-th input frame;
generating a k-th converted frame based on the k-th occupancy code and the (k−1)-th overlap frame; and
generating a k-th bitstream based on the k-th occupancy code and the (k−1)-th motion vector.

11. The method of claim 10, wherein the first to n-th input frames are included in the same intra period.

12. The method of claim 10, wherein the first to n-th input frames include detection points in different detection areas, respectively.

13. The method of claim 10, wherein the first to (k−1)-th reference frames with respect to the k-th input frame are:
a result of performing a motion compensation operation on the first to (k−1)-th converted frames on the basis of the k-th input frame, based on the first to (k−1)-th motion vectors, respectively.

14. The method of claim 10, wherein the (k−1)-th overlap frame includes:
motion compensated detection points included in each of the first to (k−1)-th reference frames with respect to the k-th input frame.

15. The method of claim 10, wherein the k-th bitstream includes a first bit area indicating an encoding scheme, a second bit area indicating the (k−1)-th motion vector, and a third bit area indicating the k-th occupancy code.

16. A method of operating a decoder which decodes first to n-th bitstreams to generate first to n-th decoded frames, the method comprising:
generating the first decoded frame based on a first occupancy code included in the first bitstream; and
sequentially performing a decoding operation on the second to n-th bitstreams to generate the second to n-th decoded frames, respectively, and
wherein the decoding operation with respect to a k-th bitstream among the second to n-th bitstreams includes:
generating first to (k−1)-th reference frames with respect to the k-th bitstream based on first to (k−1)-th motion vectors;
generating a k-th inter prediction frame based on the first to (k−1)-th reference frames with respect to the k-th bitstream; and
generating a k-th decoded frame based on the k-th inter prediction frame and a k-th occupancy code.

17. The method of claim 16, wherein the k-th inter prediction frame is:
an overlap frame generated through a union operation of the first to (k−1)-th reference frames.

18. The method of claim 17, wherein the k-th bitstream includes:
a first bit area indicating an encoding scheme;
a second bit area indicating the (k−1)-th motion vector; and
a third bit area indicating the k-th occupancy code.

19. The method of claim 16, wherein the k-th inter prediction frame is:
selected from a k-th inter prediction frame group including a plurality of overlap frames respectively generated through a union operation on arbitrary combinations of the first to (k−1)-th reference frames and the first to (k−1)-th reference frames.

20. The method of claim 19, wherein the k-th bitstream includes:
a first bit area indicating an encoding scheme;
a second bit area indicating the (k−1)-th motion vector;
a third bit area indicating the k-th occupancy code; and
a fourth bit area indicating reference frames used to generate the k-th inter prediction frame among the first to (k−1)-th reference frames.
